(19) United States
(12) Patent Application Publication
(10) Pub. No.: US 2026/0269957 A1
(43) Pub. Date: Sep. 10, 2026

(54) METHOD AND APPARATUS FOR ANTENNA CALIBRATION

(71) Applicant: Telefonaktiebolaget LM Ericsson (publ), Stockholm (SE)

(72) Inventors: Hao Zhang, Guangdong (CN); Ang Feng, Stockholm (SE); Christian Braun, Vallentuna (SE); Xiaohui Hu, Beijing (CN); Ruifang Ma, Guangdong (CN); Yueqian Wang, Beijing (CN)

(21) Appl. No.: 19/107,321

(22) PCT Filed: Aug. 29, 2022
(86) PCT No.: PCT/CN2022/115509

§ 371 Date: Feb. 27, 2025

(51) Int. Cl. H04B 17/12; H04B 7/06; H04B 17/21

(52) U.S. Cl. CPC H04B 17/12; H04B 7/0617; H04B 17/22

(57) ABSTRACT

Embodiments of the present disclosure provide method and apparatus for antenna calibration. A method performed by a wireless device comprises transmitting an antenna calibration (AC) signal in at least one antenna of an advanced antenna system (AAS). The method further comprises receiving the AC signal from the AAS via mutual coupling. The method further comprises identifying at least one interference signal in the received AC signal in a beam space. The method further comprises suppressing the at least one interference signal in the received AC signal in the beam space. The method further comprises calibrating the AAS based on the received AC signal after interference suppression.

### TECHNICAL FIELD

The non-limiting and exemplary embodiments of the present disclosure generally relate to the technical field of communications, and specifically to methods and apparatuses for antenna calibration.

### BACKGROUND

This section introduces aspects that may facilitate a better understanding of the disclosure. Accordingly, the statements of this section are to be read in this light and are not to be understood as admissions about what is in the prior art or what is not in the prior art.

In a radio access network (RAN) of a wireless communication system such as fourth generation (4G) and fifth generation (5G), a massive MIMO (Multiple Input Multiple Output) or FD-MIMO (full-dimension MIMO) technology is used to enhance cell coverage, increase throughput, improve spectrum usage, etc. A large number of antennas may be used to support this technology. In high frequency wireless networks operating at millimeter-wave (mmW) spectrum, hundreds of antennas may be employed in an antenna array, that empowers many new functionality for RAN radios.

For example, beamforming technology can create narrow beams to focus the radiated energy towards a user equipment (UE). In the multi-user MIMO environment, multiple beams are transmitted towards two or more UEs simultaneously in order to increase the throughput. There may be two key parameters to achieve good beamforming performance: the aperture of antenna array and the accuracy of antenna calibration. Larger antenna aperture leads to higher angular resolution. However, that is true only if all antenna branches are well calibrated.

Antenna Calibration (AC) is used in massive MIMO radios to compensate at least one of relative phase, delay or amplitude between multiple antenna branches of a radio or an active antenna system (AAS).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There may be two major AC solutions in existing RAN, i.e. Coupler-based AC and Mutual-coupling-based AC (MCAC). Coupler-based AC has a dedicate coupler network to establish the connection between the antennas. Therefore, coupler-based AC increases the hardware cost of a radio product. MCAC doesn't need the dedicate hardware, thus the cost is saved. It's expected that MCAC may be a more favorable AC solution in highband and mmW products which have limitation on the size. However, MCAC performance is highly depending on the coupling level between the antennas. Its result is not as accountable as that obtained from Coupler-based AC.

Both Coupler-based AC and Mutual-coupling-based AC (MCAC) are suffered from various interferences. The interference may decrease the signal-to-interference-noise-ratio (SINR) of AC signal, such as degrading the AC accuracy dramatically. Especially, MCAC utilizes the mutual coupling in the antenna array. So, the AC signal in MCAC is open to the air and doesn't have the isolation to mitigate the impact of the interference (such as external interference). Hence it has higher possibility to be interfered by the over-the-air (OTA) signals from various sources such as neighbor cell or unwanted UE.

On the other hand, leakage signals are also problematic to the AC performance. Leakage signals could be from internal or external source. For example, the leakage signal might be from the reflection of the obstacle around the radio or the AAS. Please note that MCAC might be performed during uplink (UL) or downlink (DL) slots.

A method can suppress the interference or leakage signals in a time domain. However, this method is limited by a bandwidth of a carrier and a sample rate of a receiver. If the interference or leakage signals are close to each other, or overlapped with the calibration signal, it cannot be identified and suppressed. Actually, these scenarios are common, and should be considered carefully.

To overcome or mitigate at least one above mentioned problems or other problems, an improved solution for antenna calibration may be desirable.

In a first aspect of the disclosure, there is provided a method performed by a wireless device. The method comprises transmitting an antenna calibration (AC) signal in at least one antenna of an advanced antenna system (AAS). The method further comprises receiving the AC signal from the AAS via mutual coupling. The method further comprises identifying at least one interference signal in the received AC signal in a beam space. The method further comprises suppressing the at least one interference signal in the received AC signal in the beam space.

In an embodiment, the at least one interference signal in the received AC signal comprises at least one of an external interference signal, a reflected signal from an outside object or a leakage signal.

In an embodiment, suppressing the at least one interference signal in the received AC signal in the beam space comprises suppressing at least one interference beam non-overlapped with at least one AC beam in the received AC signal in the beam space and/or suppressing at least one interference beam overlapped with the at least one AC beam in the received AC signal in the beam space.

In an embodiment, suppressing at least one interference beam non-overlapped with at least one AC beam in the received AC signal in the beam space comprises converting the received AC signal from an antenna space to the beam space to obtain a first converted AC signal, identifying at least one AC beam in the first converted AC signal, identifying at least one interference beam in the first converted AC signal, removing the at least one interference beam from the first converted AC signal, and converting the first converted AC signal removing the at least one interference beam from the beam space to the antenna space.

In an embodiment, the received AC signal is converted from the antenna space to the beam space by a spatial-domain Fourier transform (SDFT) matrix.

In an embodiment, identifying at least one AC beam in the first converted AC signal comprises obtaining a first mapping between an AC beam index in the beam space and AC signal transmission antenna index and identifying the at least one AC beam in the first converted AC signal based on the first mapping.

In an embodiment, the first mapping is pre-characterized during a production of the AAS.

In an embodiment, the first mapping is stored in the wireless device.

In an embodiment, identifying at least one interference beam in the first converted AC signal comprises constructing a first signal by removing the at least one AC beam from the first converted AC signal and when a signal strength of a beam in the first signal is larger than a threshold, identifying the beam as an interference beam.

In an embodiment, suppressing at least one interference beam overlapped with the at least one AC beam in the received AC signal in the beam space comprises adding at least one weight on at least one receiving branch of at least one antenna close to the at least one antenna of the AAS to shift the at least one AC beam to another position in the beam space to enable the at least one interference beam does not overlap with the shifted at least one AC beam; converting the received AC signal from the antenna space to the beam space to obtain a second converted AC signal, identifying the shifted at least one AC beam in the second converted AC signal, identifying the at least one interference beam in the second converted AC signal, removing the at least one interference beam from the second converted AC signal, converting the second converted AC signal removing the at least one interference beam from the beam space to the antenna space to obtain a third converted AC signal and compensating a phase shift of the third converted AC signal.

In an embodiment, identifying the shifted at least one AC beam in the second converted AC signal comprises obtaining a second mapping between a position in the beam space and the at least one weight and identifying the shifted at least one AC beam in the second converted AC signal based on the second mapping.

In an embodiment, the second mapping is pre-characterized during a production of the AAS.

In an embodiment, the second mapping is stored in the wireless device.

In an embodiment, identifying the at least one interference beam in the second converted AC signal comprises constructing a second signal by removing the shifted at least one AC beam from the second converted AC signal and when a signal strength of a beam in the second signal is larger than a threshold, identifying the beam as an interference beam.

In an embodiment, the method comprises performing a calibration on multiple receiving branches of the AAS.

In an embodiment, the method comprises determining a signal to interference plus noise ratio (SINR) of the received AC signal. When the SINR of the received AC signal is smaller than a threshold, the at least one interference signal in the received AC signal is suppressed.

In an embodiment, the method comprises determining a SINR of the received AC signal after at least one interference beam non-overlapped with at least one AC beam in the received AC signal is suppressed. When the SINR of the received AC signal after interference suppression is smaller than a threshold, at least one interference beam overlapped with the at least one AC beam in the received AC signal is suppressed.

In an embodiment, the method comprises calibrating the AAS based on the received AC signal after interference suppression.

In a second aspect of the disclosure, there is provided a wireless device. The wireless device comprises a processor and a memory coupled to the processor. Said memory contains instructions executable by said processor. The wireless device is operative to transmit an antenna calibration (AC) signal in at least one antenna of an advanced antenna system (AAS). The wireless device is further operative to receive the AC signal from the AAS via mutual coupling. The wireless device is further operative to identify at least one interference signal in the received AC signal in a beam space. The wireless device is further operative to suppress the at least one interference signal in the received AC signal in the beam space.

In a third aspect of the disclosure, there is provided a a wireless device. The wireless device comprises a transmitting module configured to transmit an antenna calibration (AC) signal in at least one antenna of an AAS. The wireless device further comprises a receiving module configured to receive the AC signal from the AAS via mutual coupling. The wireless device further comprises a identifying module configured to identify at least one interference signal in the received AC signal in a beam space. The wireless device further comprises a suppressing module configured to suppress the at least one interference signal in the received AC signal in the beam space.

In an embodiment, the wireless device further comprises a performing module configured to perform a calibration on multiple receiving branches of the AAS.

In an embodiment, the wireless device further comprises a first determining module configured to determine a signal to interference plus noise ratio (SINR) of the received AC signal. When the SINR of the received AC signal is smaller than a threshold, the at least one interference signal in the received AC signal is suppressed.

In an embodiment, the wireless device further comprises a second determining module configured to determine a SINR of the received AC signal after at least one interference beam non-overlapped with at least one AC beam in the received AC signal is suppressed. When the SINR of the received AC signal after interference suppression is smaller than a threshold, at least one interference beam overlapped with the at least one AC beam in the received AC signal is suppressed.

In an embodiment, the wireless device further comprises a calibrating module configured to calibrate the AAS based on the received AC signal after interference suppression.

In a fourth aspect of the disclosure, there is provided a computer program product comprising instructions which when executed by at least one processor, cause the at least one processor to perform the method according to the first aspect.

In fifth aspect of the disclosure, there is provided a computer-readable storage medium storing instructions which when executed by at least one processor, cause the at least one processor to perform the method according to the first aspect.

Embodiments herein may provide many advantages, of which a non-exhaustive list of examples follows. As the density of wireless devices such as gNB increases to embrace the deployment of highband, mmWave or even 6G products, the interference for MCAC may be more and more serious and challenging. In some embodiments herein, the proposed solution can suppress the interference for AC, especially MCAC, which often suffers from the interference due to reflection of obstacles, or neighbor wireless devices such as base station and/or UE. In some embodiments herein, the beam-oriented processing has a huge advantage to suppress the interference from the received signals. In some embodiments herein, the proposed solution can complement the existing interference suppression methods that cannot isolate the interference if the interference is too close to the AC signal in the time-domain. In some embodiments herein, the proposed solution can effectively avoid the accuracy degradation due to the interference, therefore improve the reliability of AC in the scenarios that the interference exists. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 schematically depicts an example of MCAC with interference and reflection signals according to an embodiment of the present disclosure;

FIG. 2a schematically shows a high level architecture in the fifth generation network according to an embodiment of the present disclosure;

FIG. 2b schematically shows system architecture in a 4G network according to an embodiment of the present disclosure;

FIG. 3 shows a flowchart of a method according to an embodiment of the present disclosure;

FIG. 4 shows a flowchart of a method according to another embodiment of the present disclosure;

FIG. 5 shows an example of AC signal in the beam space and its corresponding TX antenna in the antenna array according to an embodiment of the present disclosure;

FIG. 6 shows an example of beam space signals before and after interference suppression according to an embodiment of the present disclosure;

FIG. 7 shows an example of amplitude of signals in antenna space before and after interference suppression according to an embodiment of the present disclosure;

FIG. 8 shows an example of phase of signals in antenna space before and after interference suppression according to an embodiment of the present disclosure;

FIG. 9 shows a flowchart of a method according to another embodiment of the present disclosure;

FIG. 10 shows a flowchart of a method according to another embodiment of the present disclosure;

FIG. 11 shows an example of beam space signals before and after interference suppression according to another embodiment of the present disclosure;

FIG. 12 shows a flowchart of a method according to another embodiment of the present disclosure;

FIG. 13 shows a flowchart of a method according to another embodiment of the present disclosure;

FIG. 14 shows a flowchart of a method according to another embodiment of the present disclosure;

FIG. 15 shows a flowchart of a method of beam-oriented interference suppression for antenna calibration according to an embodiment of the present disclosure;

FIG. 16 shows a flowchart of a procedure to remove non-overlapped interference beam according to an embodiment of the present disclosure;

FIG. 17 shows a flowchart of a procedure to remove overlapped interference beam according to an embodiment of the present disclosure;

FIG. 18 is a block diagram showing an apparatus suitable for practicing some embodiments of the disclosure;

FIG. 19 is a block diagram showing a wireless device according to an embodiment of the disclosure;

FIG. 20 shows an example of a communication system according to an embodiment of the disclosure;

FIG. 21 is a block diagram of a host according to an embodiment of the disclosure; and

FIG. 22 shows a communication diagram of a host communicating via a network node with a UE over a partially wireless connection according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced (LTE-A), wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP (3rd Generation Partnership Project). For example, the communication protocols may comprise the first generation (1G), 2G, 3G, 4G, 4.5G, 5G communication protocols, and/or any other protocols either currently known or to be developed in the future.

The term “wireless device” refers to a device with radio function. An examples of the wireless device may be a network device with accessing function in a communication network via which a terminal device accesses to the network and receives services therefrom. The network device may include a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), an Integrated Access and Backhaul (IAB) node, a remote radio head (RRH), a relay, a low power node such as a femto, a pico, and so forth.

Yet further examples of the network device comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

Another example of the wireless device may be a terminal device. The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

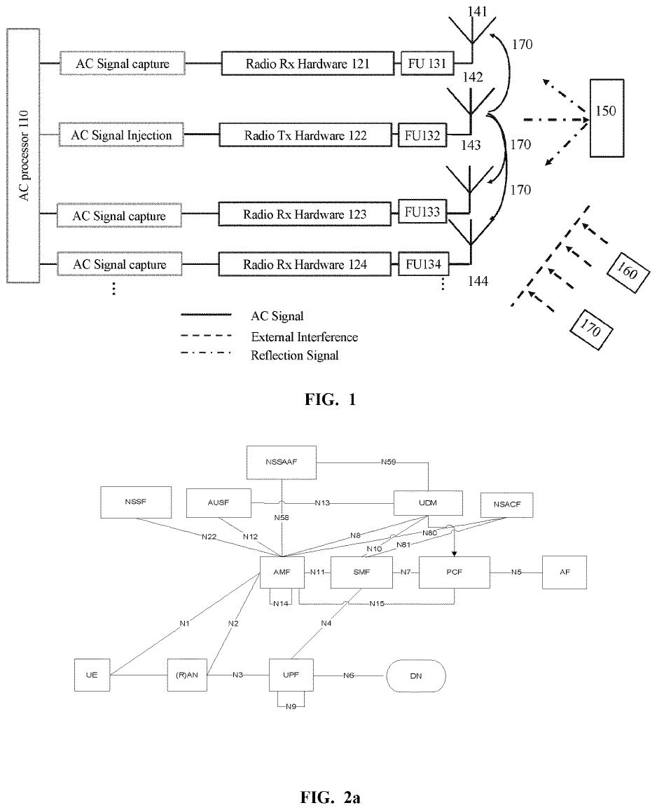

FIG. 1 schematically depicts an example of MCAC with interference and reflection signals according to an embodiment of the present disclosure.

While only four radio branches are shown, it can be appreciated that more or less radio branches can be provided. An AC signal or reference signal is injected by an AC processor 110. After passing a radio chain including a radio transmitting (TX) hardware 122 and a front end filter (FU) 132, the AC signal is transmitted via an antenna 142 and received by antennas 141, 143, and 144 via mutual coupling as shown by the arrows 170. After passing three radio chains including radio receiving (RX) hardware 121, 123 and 124 and FUs 131, 133 and 134, the AC signal is captured and processed by the AC processor 110 for AC processing and compensation, such that at least one of the phase, delay, and amplitude introduced by the AC signal path can be detected, measured, and compensated.

In addition, there may exist interference from other sources e.g. neighbor BS (base station) 160 and/or unwanted UE 170, and the leakage signals from internal or external source such as reflected from obstacles 150, etc.

To guarantee the reliability and improve the accuracy, the interference intertwined with AC signals should be suppressed. According to embodiments, it proposes a processing in beam space that can suppress the interference intertwined with AC signals. The method may be referred to as beam-oriented interference suppression.

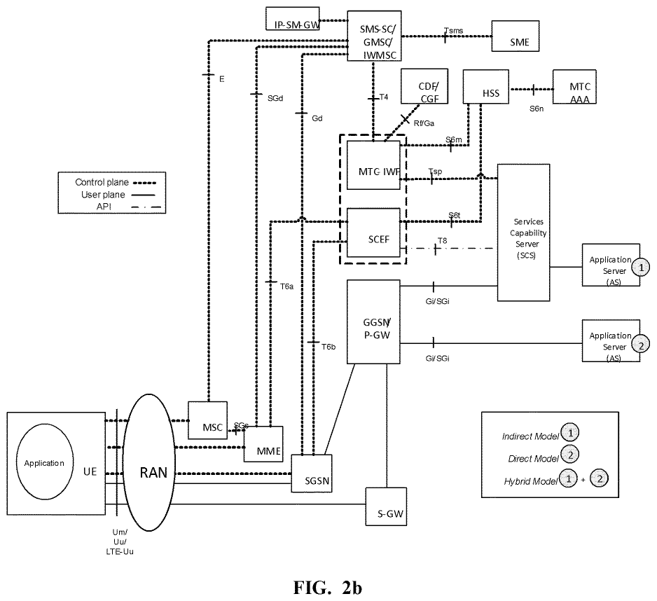

Although the subject matter described herein may be implemented in any appropriate type of system using any suitable components, the embodiments disclosed herein are described in relation to a communication system complied with the exemplary system architecture illustrated in FIGS. 2a-2b. For simplicity, the system architectures of FIGS. 2a-2b only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

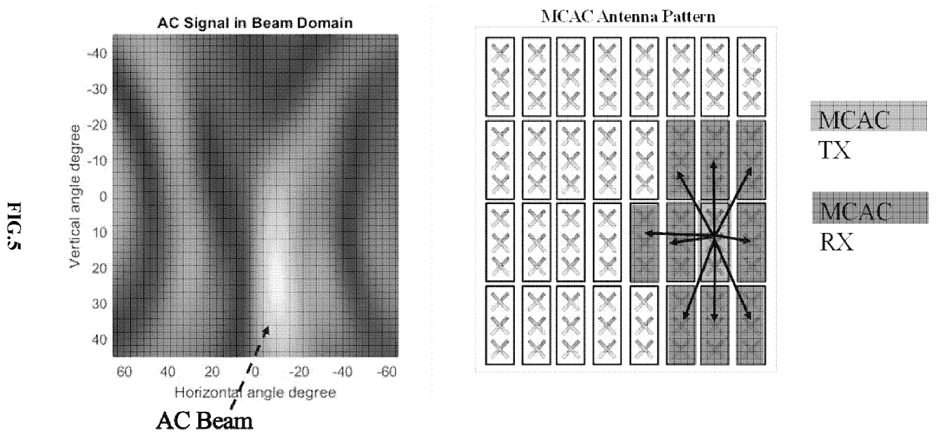

FIG. 2a schematically shows a high level architecture in the fifth generation network according to an embodiment of the present disclosure. For example, the fifth generation network may be 5GS. The architecture of FIG. 2a is same as FIG. 4.2.3-2 as described in 3GPP TS 23.501 V17.2.0, the disclosure of which is incorporated by reference herein in its entirety. The system architecture of FIG. 2a may comprise some exemplary elements such as AUSF, AMF, DN (data network), NEF, NRF, NSSF, PCF, SMF, UDM, UPF, AF, UE, (R) AN, SCP (Service Communication Proxy), NSSAAF (Network Slice-Specific Authentication and Authorization Function), NSACF (Network Slice Admission Control Function), etc.

In accordance with an exemplary embodiment, the UE can establish a signaling connection with the AMF over the reference point N1, as illustrated in FIG. 2a. This signaling connection may enable NAS (Non-access stratum) signaling exchange between the UE and the core network, comprising a signaling connection between the UE and the (R) AN and the N2 connection for this UE between the (R) AN and the AMF. The (R) AN can communicate with the UPF over the reference point N3. The UE can establish a protocol data unit (PDU) session to the DN (data network, e.g. an operator network or Internet) through the UPF over the reference point N6.

As further illustrated in FIG. 2a, the exemplary system architecture also contains some reference points such as N1, N2, N3, N4, N6, N9, N15, etc., which can support the interactions between NF services in the NFs. For example, these reference points may be realized through corresponding NF service-based interfaces and by specifying some NF service consumers and providers as well as their interactions in order to perform a particular system procedure. The AM related policy is provided by PCF to AMF for a registered UE via N15 interface. AMF can get AM policy during AM Policy Association Establishment/Modification procedure.

Various NFs shown in FIG. 2a may be responsible for functions such as session management, mobility management, authentication, security, etc. The AUSF, AMF, DN, NEF, NRF, NSSF, PCF, SMF, UDM, UPF, AF, UE, (R) AN, SCP, NSACF may include the functionality for example as defined in clause 6.2 of 3GPP TS 23.501 V17.2.0.

FIG. 2b schematically shows system architecture in a 4G network according to an embodiment of the present disclosure, which is the same as FIG. 4.2-1a of 3GPP TS 23.682 V17.2.0, the disclosure of which is incorporated by reference herein in its entirety. The system architecture of FIG. 2b may comprise some exemplary elements such as Services Capability Server (SCS), Application Server (AS), SCEF (Service Capability Exposure Function), HSS, UE, RAN (Radio Access Network), SGSN (Serving GPRS (General Packet Radio Service) Support Node), MME, MSC (Mobile Switching Centre), S-GW (Serving Gateway), GGSN/P-GW (Gateway GPRS Support Node/PDN (Packet Data Network) Gateway), MTC-IWF (Machine Type Communications-InterWorking Function) CDF/CGF (Charging Data Function/Charging Gateway Function), MTC-AAA (Machine Type Communications-authentication, authorization and accounting), SMS-SC/GMSC/IWMSC (Short Message Service-Service Centre/Gateway MSC/InterWorking MSC) IP-SM-GW (Internet protocol Short Message Gateway). The network elements and interfaces as shown in FIG. 2b may be same as the corresponding network elements and interfaces as described in 3GPP TS 23.682 V17.2.0.

The system architecture shows the architecture for a UE used for MTC connecting to the 3GPP network (UTRAN (Universal Terrestrial Radio Access Network), E-UTRAN (Evolved UTRAN), GERAN (GSM EDGE (Enhanced Data rates for GSM Evolution) Radio Access Network), etc.) via the Um/Uu/LTE-Uu interfaces. The system architecture also shows the 3GPP network service capability exposure to SCS and AS.

As further illustrated in FIG. 2b, the exemplary system architecture also contains various reference points.

Tsms: Reference point used by an entity outside the 3GPP network to communicate with UEs used for MTC via SMS (Short Message Service).

Tsp: Reference point used by a SCS to communicate with the MTC-IWF related control plane signalling.

T4: Reference point used between MTC-IWF and the SMS-SC in the HPLMN.

T6a: Reference point used between SCEF and serving MME.

T6b: Reference point used between SCEF and serving SGSN.

T8: Reference point used between the SCEF and the SCS/AS.

Som: Reference point used by MTC-IWF to interrogate HSS/HLR (Home Location Register).

Son: Reference point used by MTC-AAA to interrogate HSS/HLR.

S6t: Reference point used between SCEF and HSS.

SGs: Reference point used between MSC and MME.

Gi/SGi: Reference point used between GGSN/P-GW and application server and between GGSN/P-GW and SCS.

Rf/Ga: Reference point used between MTC-IWF and CDF/CGF.

Gd: Reference point used between SMS-SC/GMSC/IWMSC and SGSN.

SGd: Reference point used between SMS-SC/GMSC/IWMSC and MME.

E: Reference point used between SMS-SC/GMSC/IWMSC and MSC.

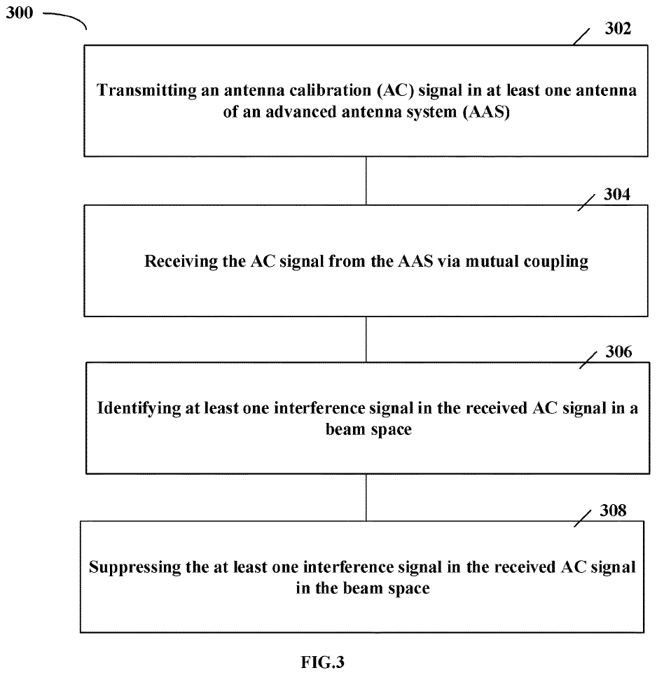

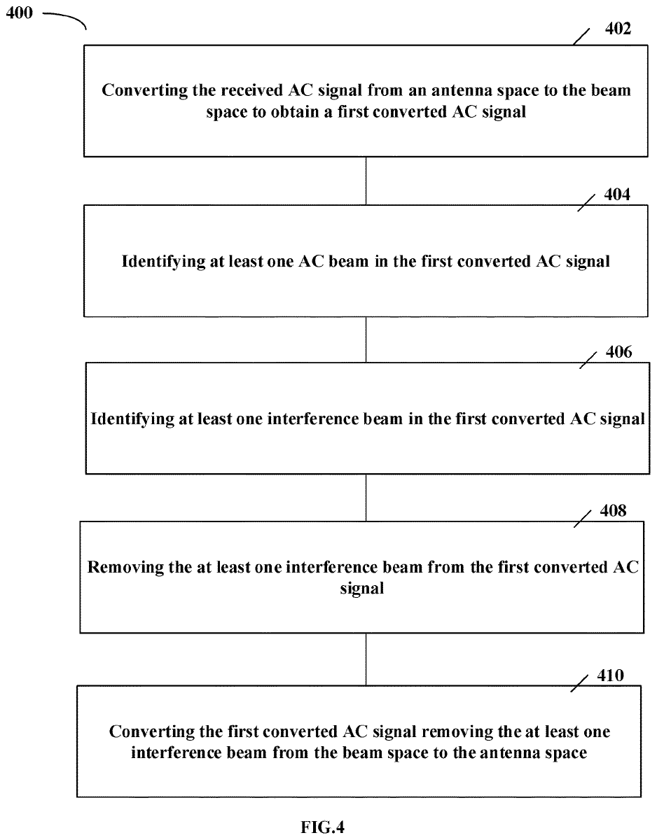

FIG. 3 shows a flowchart of a method according to an embodiment of the present disclosure, which may be performed by an apparatus implemented in or at or as a wireless device or communicatively coupled to the wireless device. As such, the apparatus may provide means or modules for accomplishing various parts of the method 300 as well as means or modules for accomplishing other processes in conjunction with other components.

At block 302, the wireless device may transmit an antenna calibration (AC) signal in at least one antenna of an advanced antenna system (AAS).

In an embodiment, the wireless device may transmit the AC signal in one antenna of the AAS.

The AAS may comprise multiple antennas or an antenna array. The AAS may be any suitable AAS.

The wireless device may be any suitable radio device which can use multiple antennas such as AAS or antenna array to transmit and/or receive information such as message or data. In an embodiment, the wireless device may be a network device such as base station (e.g., eNB, gNB, etc). In another embodiment, the wireless device may be a terminal device.

An antenna array (often called a ‘phased array’) is a set of two or more antennas. The signals from the antenna array are combined or processed in order to achieve improved performance over that of a single antenna. The antenna array may be any suitable antenna array and the present disclosure has no limit on it.

The AC signal may be any suitable AC signal and the present disclosure has no limit on it. For example, the wireless device may generate a radio signal only for the purpose of AC.

The AC signal may be scheduled after some critical or important signaling messages and/or data are scheduled. In an embodiment, the AC signal may be MCAC signal.

At block 304, the wireless device may receive the AC signal from the AAS via mutual coupling.

In the AAS, mutual coupling is the electromagnetic interaction between the antenna elements in an antenna array.

For example, the wireless device may receive the AC signal from the AAS via mutual coupling as shown in FIG. 1.

At block 306, the wireless device may identify at least one interference signal in the received AC signal in a beam space.

The wireless device may identify at least one interference signal in the received AC signal in the beam space by various suitable methods. For example, the wireless device may convert the received AC signal from an antenna space to the beam space. The wireless device may identify the AC beam(s) in the beam space based on a mapping between an AC beam index in the beam space and AC signal transmission antenna index. Then the wireless device may identify the other beam(s) as interference beam in the beam space. For example, the signal strength of a candidate interference beam may be compared with a threshold. If the signal strength of the candidate interference beam is larger than the threshold, it can be considered as an interference signal.

At block 308, the wireless device may suppress the at least one interference signal in the received AC signal in the beam space.

In an embodiment, the at least one interference signal in the received AC signal comprises at least one of an external interference signal, a reflected signal from an outside object or a leakage signal.

As described above, both Coupler-based AC and MCAC are suffered from various interferences. The interference may decrease the SINR of AC signal, such as degrading the AC accuracy dramatically. Especially, MCAC utilizes the mutual coupling in the AAS. So, the AC signal in MCAC is open to the air and doesn't have the isolation to mitigate the impact of the interference (such as external interference). Hence it has higher possibility to be interfered by the over-the-air (OTA) signals from various sources such as neighbor cell or unwanted UE. On the other hand, leakage signals are also problematic to the AC performance. Leakage signals could be from internal or external source. For example, the leakage signal might be from the reflection of the obstacle around the radio or the AAS. The leakage signal may be the undesired leakage signal within the AAS. The reflected signal may be the reflected signal of the AC signal.

The wireless device may suppress at least one interference signal in the received AC signal in the beam space by various suitable methods.

For example, the interference suppression processing may be as following. The 1st step is to convert the original AC signals from antenna space (or antenna domain) to beam space. The 2nd step is to identify the AC signal and the interference signal. The 3rd step is to suppress the interference signal. The 4th step is to convert the purified AC signals from the beam space to the antenna space.

In the beam space, the AC beam may not overlap with the interference beam. In an embodiment, the wireless device may suppress at least one interference beam non-overlapped with at least one AC beam in the received AC signal in the beam space.

For example, the wireless device may convert the received AC signal from an antenna space to the beam space. The wireless device may identify at least one AC beam and at least one interference beam. The wireless device may remove the at least one interference beam from the converted AC signal to get a purified AC signal. Finally, the wireless device can convert the purified AC signal from the beam space to the antenna space.

In the beam space, the AC beam may overlap with the interference beam. In an embodiment, the wireless device may suppress at least one interference beam overlapped with the at least one AC beam in the received AC signal in the beam space.

For example, the wireless device may shift the at least one AC beam to another position in the beam space to enable the at least one interference beam does not overlap with the shifted at least one AC beam. The wireless device may convert the received AC signal from the antenna space to the beam space. The wireless device may identify the shifted at least one AC beam and at least one interference beam. The wireless device may remove the at least one interference beam from the converted AC signal to get a purified AC signal. The wireless device can convert the purified AC signal from the beam space to the antenna space. The wireless device can compensate a phase shift of the purified AC signal.

FIG. 4 shows a flowchart of a method according to another embodiment of the present disclosure, which may be performed by an apparatus implemented in or at or as a wireless device or communicatively coupled to the wireless device. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, the wireless device may convert the received AC signal from an antenna space to the beam space to obtain a first converted AC signal.

The received AC signal may be converted from the antenna space to the beam space by using any suitable methods and the present disclosure has no limit on it.

In an embodiment, the received AC signal may be converted from the antenna space to the beam space by a spatial-domain Fourier transform (SDFT) matrix.

For example, the SDFT matrix may be constructed as below formula (1). R_{H} is the horizontal matrix. H is the number of columns for the antenna array. R_{V} is the vertical matrix. V is the number of rows for the antenna array. R_{P} is the matrix for polarization. The conversion matrix C is the Kronecker product of R_{P}, R_{H} and R_{V}.

$${R}_{H} = 1 / \sqrt{H} [ \begin{matrix}1 & 1 & … & 1 \\ {e}^{- {m}_{0}} & {e}^{- {m}_{1}} & … & {e}^{- {m}_{H - 1}} \\ ⋮ & ⋮ & ⋱ & ⋮ \\ {e}^{- ( H - 1 ) {m}_{0}} & {e}^{- ( H - 1 ) {m}_{1}} & … & {e}^{- ( H - 1 ) {m}_{H - 1}}\end{matrix} ] , {m}_{k} = \frac{j 2 π k}{H} \qquad ( 1 )$$

$${R}_{H} = 1 / \sqrt{V} [ \begin{matrix}1 & 1 & … & 1 \\ {e}^{- {n}_{0}} & {e}^{- {n}_{1}} & … & {e}^{- {n}_{V - 1}} \\ ⋮ & ⋮ & ⋱ & ⋮ \\ {e}^{- ( V - 1 ) {n}_{0}} & {e}^{- ( V - 1 ) {n}_{1}} & … & {e}^{- ( V - 1 ) {n}_{V - 1}}\end{matrix} ] , {n}_{k} = \frac{j 2 π k}{V}$$

$${R}_{P} = [ \begin{matrix}1 & 0 \\ 0 & 1\end{matrix} ]$$

$$C = {R}_{P} ⊗ {R}_{H} ⊗ {R}_{V}$$

With the conversion matrix C, the received AC signal X in the antenna space can be converted to Y in the beam space, as shown as below formula (2). a is the antenna index. b is the beam index. a, b=1, 2, . . . , 2VH. It's worth noting that there are multiple AC signals for multiple transmitting antennas in MCAC. For simplicity we use one AC signal for illustration and the processing should be done for every MCAC transmitting antenna. X(a) is a vector which is received AC signal in all RX antenna branches. Y(b) is also a vector which is the AC signal expressed in the beam space.

$$Y ( b ) = CX ( a ) \qquad ( 2 )$$

At block 404, the wireless device may identify at least one AC beam in the first converted AC signal.

The wireless device may identify at least one AC beam in the first converted AC signal in various ways. For example, the wireless device may identify at least one AC beam in the first converted AC signal based on the feature of the at least one AC beam. The wireless device may try to decode the beam in the first converted AC signal to find out which beam is the AC beam.

In an embodiment, the wireless device may obtain a first mapping between an AC beam index in the beam space and AC signal transmission antenna index. The wireless device may identify the at least one AC beam in the first converted AC signal based on the first mapping.

In an embodiment, the first mapping is pre-characterized during a production of the AAS.

In an embodiment, the first mapping is stored in the wireless device.

Unlike far field signals, MCAC signal is a near field signal so it might cover multiple beams. FIG. 5 shows an example of AC signal in the beam space and its corresponding TX antenna in the antenna array according to an embodiment of the present disclosure. In this embodiment, the AC signal covers two beams. In other embodiments, the AC signal may cover more or less beams. In MCAC, it may transmit one AC signal in one TX antenna branch/subarray and receive it in the neighbor RX antenna branch/subarrays. Hence, each MCAC TX antenna signal may have its unique position in the beam space.

The received AC signal of each TX antenna may correspond to different beams. The mapping of AC signal between RX beam indexes and TX antenna index may be pre-characterized during a production of the AAS. Alternatively, the mapping of AC signal between RX beam indexes and TX antenna index may be obtained by experiment. Here

$${b}_{{AC}_{i}}^{{TX}_{n}}$$

is used to denote the AC beam index corresponding to TXₙ. Every TX antenna has its own AC beam(s) whose index Aᵢ for i=1 . . . . I would be written into a database of the wireless device to be used in runtime. The maximum number of beams occupied by one TX branch is denoted as I. In this example, it assumes I=2. But I can be any positive integer number in other embodiments.

At block 406, the wireless device may identify at least one interference beam in the first converted AC signal.

The wireless device may identify at least one interference beam in the first converted AC signal in various ways. For example, the wireless device may identify at least one interference beam in the first converted AC signal based on the feature of the at least one interference beam. The wireless device may try to decode the beam in the first converted AC signal to find out which beam is the AC beam. After finding out the AC beam(s), the other beam(s) may be interference beam(s).

In an embodiment, the wireless device may construct a first signal by removing the at least one AC beam from the first converted AC signal. When a signal strength of a beam in the first signal is larger than a threshold, the wireless device may identify the beam as an interference beam.

At block 408, the wireless device may remove the at least one interference beam from the first converted AC signal.

At block 410, the wireless device may convert the first converted AC signal removing the at least one interference beam from the beam space to the antenna space.

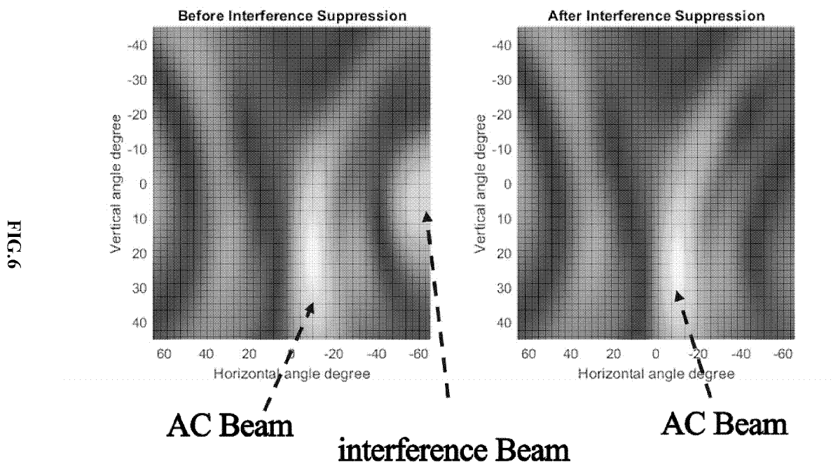

FIG. 6 shows an example of beam space signals before and after interference suppression according to an embodiment of the present disclosure.

The left figure of FIG. 6 shows an example of the MCAC signals with a large interference e.g. from a neighbor cell. The right figure of FIG. 6 shows an example of MCAC signals after interference signal is removed. To suppress or cancel the interference signal, it needs to find out the interference beam. The AC beam may be constructed by the following formula (3). Y is the measured beam space signals in the runtime. b is the beam index from the database. Firstly, it can take the beams with AC signal only, which is the Y′. It could include more or less beams while here it takes two AC beams

$${b}_{{AC}_{i}}^{{TX}_{n}} and {b}_{{AC}_{j}}^{{TX}_{n}} ,$$

which may be a typical example.

$${Y}^{′} = Y ( {b}_{{AC}_{i}}^{{TX}_{n}} ) + Y ( {b}_{{AC}_{j}}^{{TX}_{n}} ) \qquad ( 3 )$$

Then it can construct the Y″ which is the signal with interference only as below formula (4). The largest beam in Y″ can be found and compared with a threshold. The threshold may be any suitable value. If |Y″(I)| is larger than the threshold, it can be considered as an interference signal e.g. from OTA. Then it would be removed from Y. Y′″ is the beam space signal after the interference suppression as below formula (5).

$${Y}^{″} = Y - {Y}^{′} \qquad ( 4 )$$

I=arg max|_{b} Y″(b)|, for b=1: 2VH

$${Y}^{′′′} = Y - {Y}^{″} ( I ) , if \vert {Y}^{″} ( I ) \vert > threshold \qquad ( 5 )$$

Then it can get the antenna space signal X′ after the interference suppression as below formula (6), by applying the inversion of conversion matrix C.

$${X}^{′} = {C}^{- 1} {Y}^{′′′} \qquad ( 6 )$$

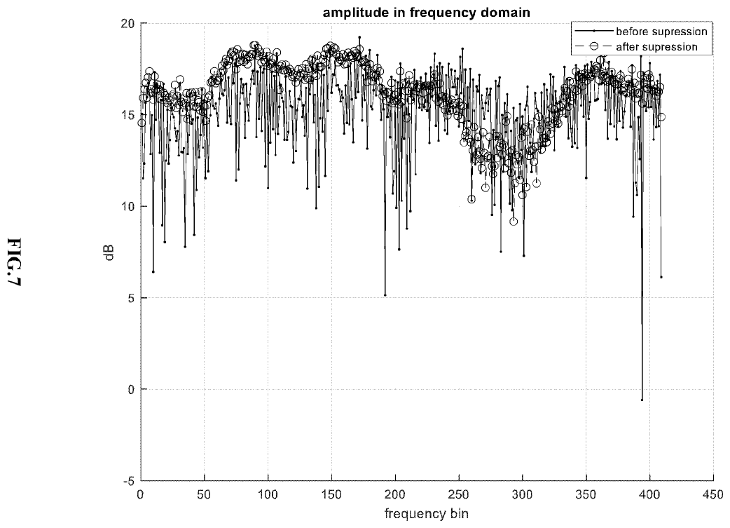

FIG. 7 shows an example of amplitude of signals in antenna space before and after interference suppression according to an embodiment of the present disclosure.

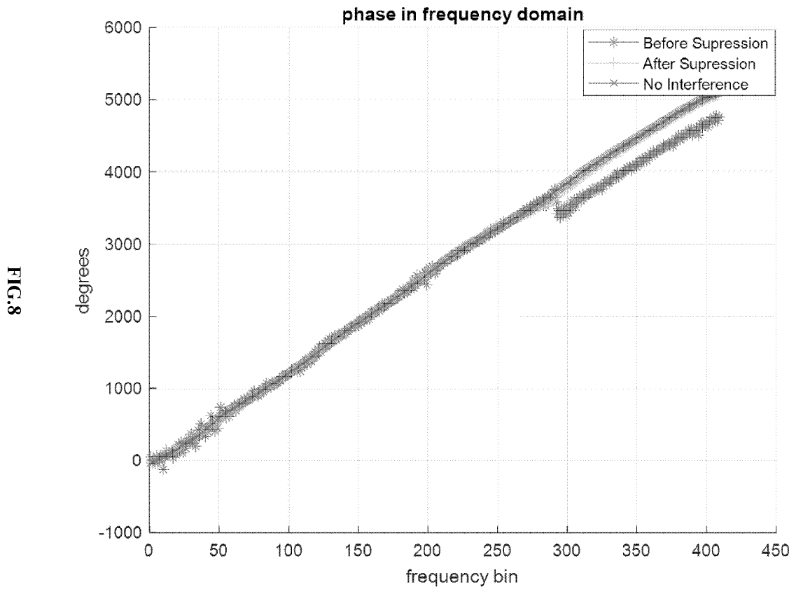

FIG. 8 shows an example of phase of signals in antenna space before and after interference suppression according to an embodiment of the present disclosure.

As shown in FIGS. 7-8, the interference in antenna space is also suppressed

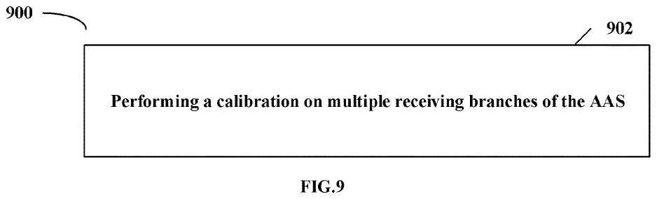

FIG. 9 shows a flowchart of a method according to another embodiment of the present disclosure, which may be performed by an apparatus implemented in or at or as a wireless device or communicatively coupled to the wireless device. As such, the apparatus may provide means or modules for accomplishing various parts of the method 900 as well as means or modules for accomplishing other processes in conjunction with other components. For some parts which have been described in the above embodiments, the description thereof is omitted here for brevity.

At block 902, the wireless device may perform a calibration on multiple receiving branches of the AAS.

For example, uncalibrated radio/AAS needs an initial or coarse calibration on RX branches before using the proposed beam-oriented interference suppression for antenna calibration. The initial or coarse calibration on RX branches can be done by any solution, for example the OTA AC technology (such as WO2022010389A1) which uses UE signals to do initial calibration. After the initial calibration, the radio/AAS may have a decent calibration performance to use the beam-oriented processing.

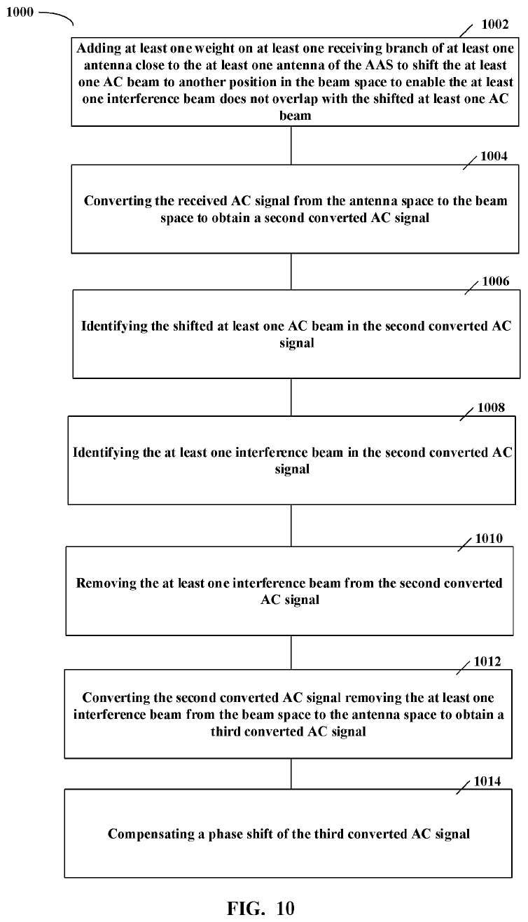

FIG. 10 shows a flowchart of a method according to another embodiment of the present disclosure, which may be performed by an apparatus implemented in or at or as a wireless device or communicatively coupled to the wireless device. As such, the apparatus may provide means or modules for accomplishing various parts of the method 1000 as well as means or modules for accomplishing other processes in conjunction with other components. For some parts which have been described in the above embodiments, the description thereof is omitted here for brevity.

At block 1002, the wireless device may add at least one weight on at least one receiving branch of at least one antenna close to the at least one antenna of the AAS to shift the at least one AC beam to another position in the beam space to enable the at least one interference beam does not overlap with the shifted at least one AC beam.

For example, in some cases, the interference beam might be overlapped with the AC beam. FIG. 11 shows an example of beam space signals before and after interference suppression according to another embodiment of the present disclosure. As shown in the left figure of FIG. 11, it cannot find out the interference beam directly since the interference beam is overlapped with the AC beam. To overcome this issue, this embodiment provides a solution to adjust the AC beam to another beam position.

The rationale of this solution is, for MCAC there are only a few RX antenna branches that can receive non-trivial AC signals. For example, the major RX antenna branches may be the 1st neighbor subarrays around the transmitting antenna. Hence, it can shift the AC beam position by applying weights in a couple of major RX antenna branches as below formula (7). In the meantime, the position of interference beam is almost unchanged because the weights are only applied on a few RX antenna branches.

The solution is described as follows: X is the antenna space signal containing both AC signals and interference signals before the adjustment. X is the antenna space signal after the adjustment. W is the weight applied to the received signals. a is the antenna index. N is the number of antennas.

$$\tilde{X} = WX \qquad ( 7 )$$

$$W = [ {w}_{1} , … , {w}_{a} , … , {w}_{N} ]$$

$${w}_{a} = {e}^{j 2 π {θ}_{a}}$$

In the example of FIG. 11, the branch index for TX antenna is m while the two neighbor receiving branches are i and j. By adding the weights on the receiving branches i and j in antenna space, it can shift the AC beam to another position in the beam space as below. Only wᵢ and wⱼ have a phase shift, while the other antenna signals have no phase shift. With such solution, it can keep the interference beam almost unchanged because it's received in all RX branches.

$$W = [ 1 , … , 1 , {w}_{i} , 1 … , 1 , {w}_{j} , 1 , … , 1 ]$$

$${w}_{i} = {e}^{j 2 π k {θ}_{i}}$$

$${w}_{j} = {e}^{j 2 π k {θ}_{j}}$$

θᵢ & θⱼ and its adjusted position can also be pre-characterized in a production of the AAS and saved in database of the wireless device.

As shown in FIG. 11, it can find out the beam space signals comparison between Y=CX (the left figure of FIG. 11 before AC beam adjustment) and \tilde{Y}=C\tilde{X} (the right figure of FIG. 11 after AC beam adjustment). As a result the AC beam has changed its position while the interference beam position has no change.

At block 1004, the wireless device may convert the received AC signal from the antenna space to the beam space to obtain a second converted AC signal. Block 1004 may be similar to block 402 of FIG. 4.

At block 1006, the wireless device may identify the shifted at least one AC beam in the second converted AC signal.

In an embodiment, the wireless device may obtain a second mapping between a position in the beam space and the at least one weight, the wireless device may identify the shifted at least one AC beam in the second converted AC signal based on the second mapping.

In an embodiment, the second mapping is pre-characterized during a production of the AAS.

In an embodiment, the second mapping is stored in the wireless device.

For example, since the weights and its adjusted position may be pre-characterized in a production of the AAS and saved in database of the wireless device, the wireless device may identify the shifted at least one AC beam in the second converted AC signal.

At block 1008, the wireless device may identify the at least one interference beam in the second converted AC signal. Block 1008 may be similar to block 406 of FIG. 4.

In an embodiment, the wireless device may construct a second signal by removing the shifted at least one AC beam from the second converted AC signal. The wireless device may identifying the beam as an interference beam when a signal strength of a beam in the second signal is larger than a threshold.

At block 1010, the wireless device may remove the at least one interference beam from the second converted AC signal.

At block 1012, the wireless device may convert the second converted AC signal removing the at least one interference beam from the beam space to the antenna space to obtain a third converted AC signal. Block 1012 may be similar to block 410 of FIG. 4.

At block 1014, the wireless device may compensate a phase shift of the third converted AC signal. In this way, the AC signal may be shifted to its original positions.

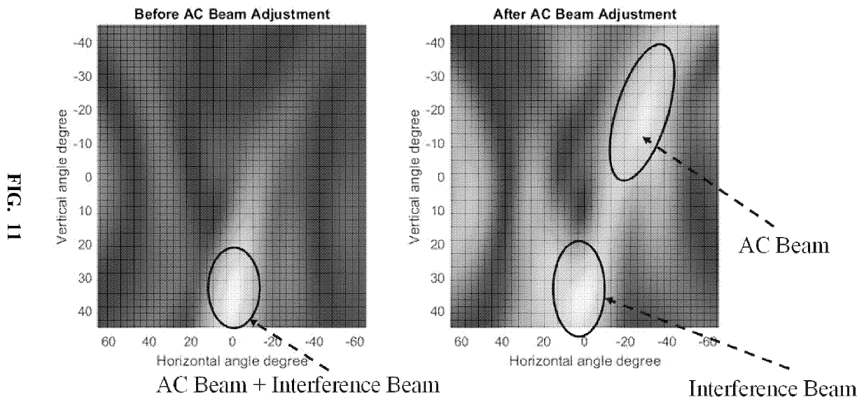

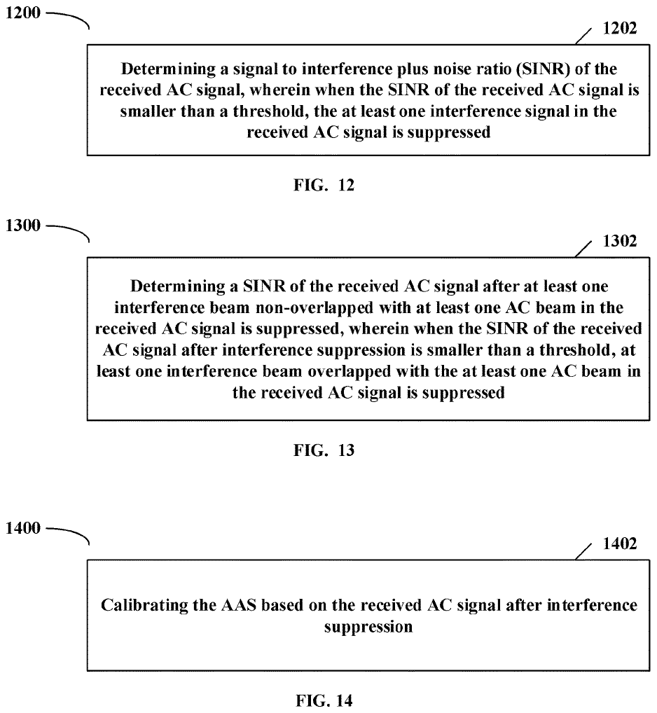

FIG. 12 shows a flowchart of a method according to another embodiment of the present disclosure, which may be performed by an apparatus implemented in or at or as a wireless device or communicatively coupled to the wireless device. As such, the apparatus may provide means or modules for accomplishing various parts of the method 1200 as well as means or modules for accomplishing other processes in conjunction with other components. For some parts which have been described in the above embodiments, the description thereof is omitted here for brevity.

At block 1202, the wireless device may determine a signal to interference plus noise ratio (SINR) of the received AC signal. When the SINR of the received AC signal is smaller than a threshold, the at least one interference signal in the received AC signal is suppressed. For example, the wireless device may suppress at least one interference beam non-overlapped with at least one AC beam in the received AC signal in the beam space and/or suppress at least one interference beam overlapped with the at least one AC beam in the received AC signal in the beam space.

FIG. 13 shows a flowchart of a method according to another embodiment of the present disclosure, which may be performed by an apparatus implemented in or at or as a wireless device or communicatively coupled to the wireless device. As such, the apparatus may provide means or modules for accomplishing various parts of the method 1300 as well as means or modules for accomplishing other processes in conjunction with other components. For some parts which have been described in the above embodiments, the description thereof is omitted here for brevity.

At block 1302, the wireless device may determine a SINR of the received AC signal after at least one interference beam non-overlapped with at least one AC beam in the received AC signal is suppressed. When the SINR of the received AC signal after interference suppression is smaller than a threshold, at least one interference beam overlapped with the at least one AC beam in the received AC signal is suppressed.

FIG. 14 shows a flowchart of a method according to another embodiment of the present disclosure, which may be performed by an apparatus implemented in or at or as a wireless device or communicatively coupled to the wireless device. As such, the apparatus may provide means or modules for accomplishing various parts of the method 1400 as well as means or modules for accomplishing other processes in conjunction with other components. For some parts which have been described in the above embodiments, the description thereof is omitted here for brevity.

At block 1402, the wireless device may calibrate the AAS based on the received AC signal after interference suppression. The wireless device may calibrate the AAS based on the received AC signal after interference suppression using any suitable calibration methods and the present disclosure has no limit on it.

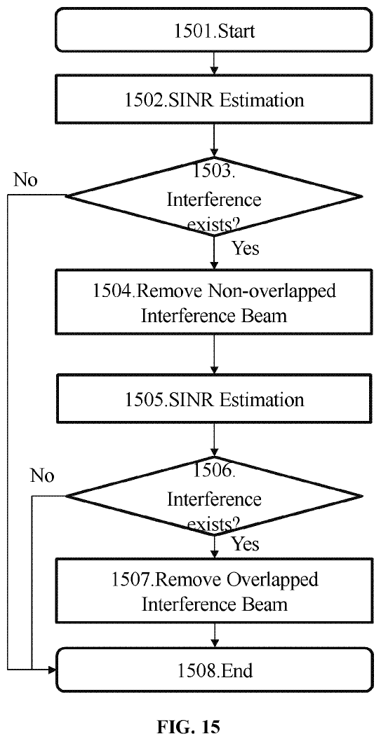

FIG. 15 shows a flowchart of a method of beam-oriented interference suppression for antenna calibration according to an embodiment of the present disclosure.

At block 1501. The wireless device may start the method of beam-oriented interference suppression for antenna calibration.

At block 1502. The wireless device may perform SINR estimation of the received AC signal.

At block 1503. The wireless device may determine whether interference in the received AC signal exists.

At block 1504. The wireless device may remove non-overlapped interference beam in the received AC signal if the interference in the received AC signal exists. Otherwise the wireless device may end the method of beam-oriented interference suppression for antenna calibration at block 1508.

At block 1505. The wireless device may perform SINR estimation of the received AC signal after removing non-overlapped interference beam in the received AC signal.

At block 1506. The wireless device may determine whether interference in the received AC signal after removing non-overlapped interference beam in the received AC signal exists.

At block 1507. The wireless device may remove overlapped interference beam in the received AC signal if the interference in the received AC signal still exists (i.e., there is overlapped interference beam in the received AC signal). Otherwise the wireless device may end the method of beam-oriented interference suppression for antenna calibration at block 1508.

At block 1508. The wireless device may end the method of beam-oriented interference suppression for antenna calibration.

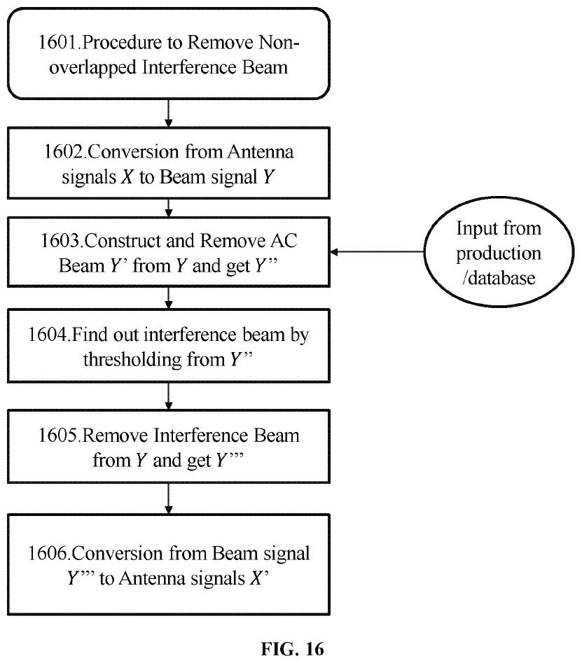

FIG. 16 shows a flowchart of a procedure to remove non-overlapped interference beam according to an embodiment of the present disclosure.

At block 1601. The wireless device may start the procedure to remove non-overlapped interference beam.

At block 1602. The wireless device may convert the received AC signal from antenna signals X to beam signal Y.

At block 1603. The wireless device may construct and remove AC beam Y′ from Y and get Y″. In this block, the wireless device may obtain a first mapping between an AC beam index in the beam space and AC signal transmission antenna index, which may be input from a production of the AAS or a database.

At block 1604. The wireless device may find out interference beam by thresholding from Y″.

At block 1605. The wireless device may remove interference beam from Y and get

At block 1606. The wireless device may convert the beam signal Y″′ to antenna signals X′.

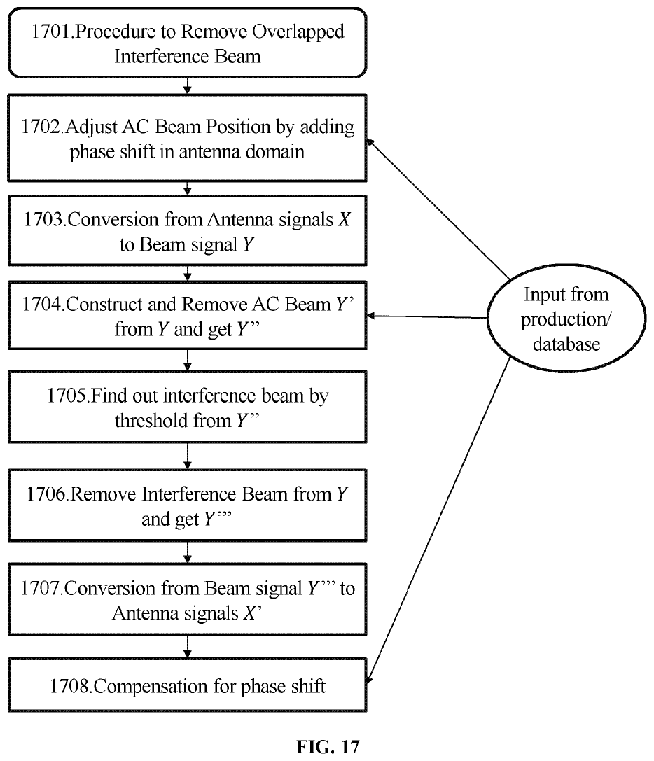

FIG. 17 shows a flowchart of a procedure to remove overlapped interference beam according to an embodiment of the present disclosure.

At block 1701. The wireless device may start the procedure to remove overlapped interference beam.

At block 1702. The wireless device may adjust AC beam position by adding phase shift in antenna domain. In this block, the wireless device may obtain a mapping between a position in the beam space and the phase shift, which may be input from a production of the AAS or a database.

At block 1703. The wireless device may convert the antenna signals X to beam signal Y.

At block 1704. The wireless device may construct and remove AC beam Y′ from Y and get Y”. In this block, the wireless device may obtain a mapping between a position in the beam space and the phase shift, which may be input from a production of the AAS or a database.

At block 1705. The wireless device may find out interference beam by a threshold from Y″.

At block 1706. The wireless device may remove interference beam from Y and get Y″′.

At block 1707. The wireless device may convert beam signal Y″′ to antenna signals X′.

At block 1708. The wireless device may compensate for phase shift. In this block, the wireless device may obtain a mapping between a position in the beam space and the phase shift, which may be input from a production of the AAS or a database.

According to various embodiments, it proposes a beam-oriented interference suppression method that can effectively suppress the interference in the beam space. The method exploits the unique beam position of the AC beam to separate it from other incoming signals (e.g., interference signals). The interference can be the leakage signals from either internal or external source. For some special scenarios in which the interference and the AC signal are overlapped in the beam space, it also proposes an enhanced method that adjusts the AC beam to another beam position. Consequently, the method can be deployed in most scenarios no matter of which position is occupied by the interference. Simulations confirm that the proposed method can improve the reliability of AC to overcome the accuracy degradation due to the interference or the leakage signals.

The proposed beam-oriented interference suppression method may exploit the difference between the AC signal and the interference in the beam space, and suppress the interference to improve the accuracy of AC. The wireless device may convert the original AC signals from antenna space to beam space, identify AC beam and interference beam in beam space, remove the interference beam while keep the AC beam, and convert the purified AC signals from beam space to antenna space.

To overcome the scenario in which the AC beam and the interference beam are overlapped, it also propose an enhanced method that can adjust the AC beam to another beam position. The wireless device may separate the AC beam and interference beam by applying weights on a few receiving antennas. To guarantee the effectiveness of the method, additional processes are also included: AC beam characterization during production and initial calibration to have moderate AC error.

Embodiments herein may provide many advantages, of which a non-exhaustive list of examples follows. As the density of wireless devices such as gNB increases to embrace the deployment of highband, mmWave or even 6G products, the interference for MCAC may be more and more serious and challenging. In some embodiments herein, the proposed solution can suppress the interference for AC, especially MCAC, which often suffers from the interference due to reflection of obstacles, or neighbor wireless devices such as base station and/or UE. In some embodiments herein, the beam-oriented processing has a huge advantage to suppress the interference from the received signals. In some embodiments herein, the proposed solution can complement the existing interference suppression methods that cannot isolate the interference if the interference is too close to the AC signal in the time-domain. In some embodiments herein, the proposed solution can effectively avoid the accuracy degradation due to the interference, therefore improve the reliability of AC in the scenarios that the interference exists. The embodiments herein are not limited to the features and advantages mentioned above. A person skilled in the art will recognize additional features and advantages upon reading the following detailed description.

FIG. 18 is a block diagram showing an apparatus suitable for practicing some embodiments of the disclosure. For example, wireless device may be implemented as or through the apparatus 1800.

The apparatus 1800 comprises at least one processor 1821, such as a digital processor (DP), and at least one memory (MEM) 1822 coupled to the processor 1821. The apparatus 1800 may further comprise a transmitter TX and receiver RX 1823 coupled to the processor 1821. The MEM 1822 stores a program (PROG) 1824. The PROG 1824 may include instructions that, when executed on the associated processor 1821, enable the apparatus 1800 to operate in accordance with the embodiments of the present disclosure. A combination of the at least one processor 1821 and the at least one MEM 1822 may form processing means 825 adapted to implement various embodiments of the present disclosure.

Various embodiments of the present disclosure may be implemented by computer program executable by one or more of the processor 1821, software, firmware, hardware or in a combination thereof.

The MEM 1822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 1821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the wireless device, the memory 1822 contains instructions executable by the processor 1821, whereby the wireless device operates according to any of the methods related to the wireless device as described above.

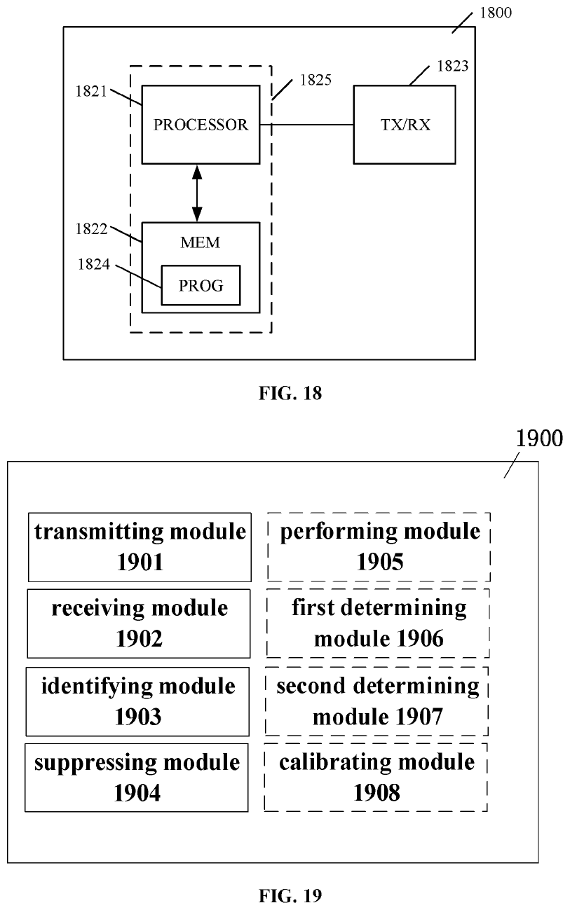

FIG. 19 is a block diagram showing a wireless device according to an embodiment of the disclosure. As shown, the wireless device 1900 comprises a transmitting module 1901 configured to transmit an antenna calibration (AC) signal in at least one antenna of an AAS. The wireless device 1900 further comprises a receiving module 1902 configured to receive the AC signal from the AAS via mutual coupling. The wireless device 1900 further comprises a identifying module 1903 configured to identify at least one interference signal in the received AC signal in a beam space. The wireless device 1900 further comprises a suppressing module 1904 configured to suppress the at least one interference signal in the received AC signal in the beam space.

In an embodiment, the wireless device 1900 further comprises a performing module 1905 configured to perform a calibration on multiple receiving branches of the AAS.

In an embodiment, the wireless device 1900 further comprises a first determining module 1906 configured to determine a signal to interference plus noise ratio (SINR) of the received AC signal. When the SINR of the received AC signal is smaller than a threshold, the at least one interference signal in the received AC signal is suppressed.

In an embodiment, the wireless device 1900 further comprises a second determining module 1907 configured to determine a SINR of the received AC signal after at least one interference beam non-overlapped with at least one AC beam in the received AC signal is suppressed. When the SINR of the received AC signal after interference suppression is smaller than a threshold, at least one interference beam overlapped with the at least one AC beam in the received AC signal is suppressed.

In an embodiment, the wireless device 1900 further comprises a calibrating module 1908 configured to calibrate the AAS based on the received AC signal after interference suppression.

With function units, the wireless device may not need a fixed processor or memory, any computing resource and storage resource may be arranged from the wireless device in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

Further, the exemplary overall commutation system including the terminal device and the network node will be introduced as below.

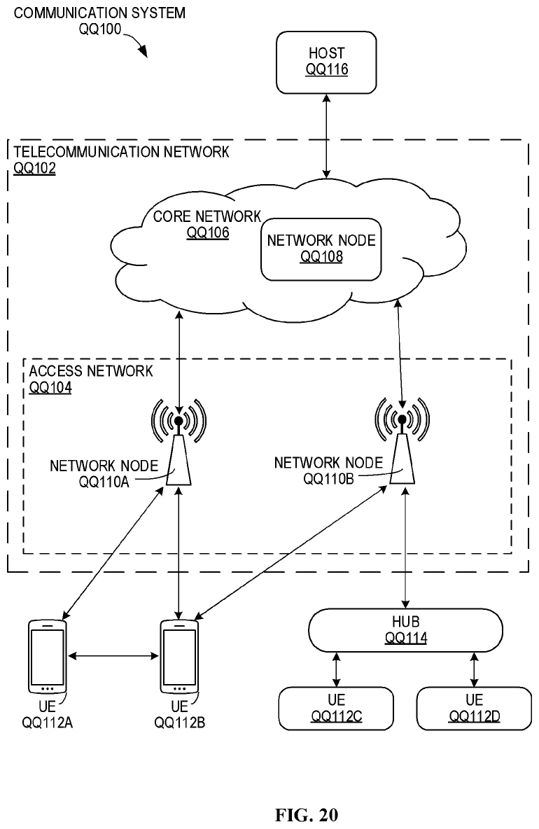

FIG. 20 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 20 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

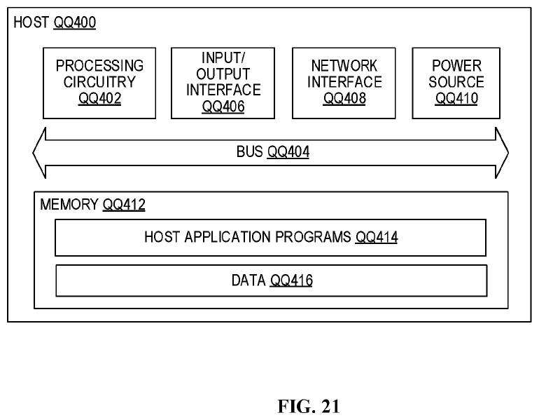

FIG. 21 is a block diagram of a host QQ400, which may be an embodiment of the host QQ116 of FIG. 20, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

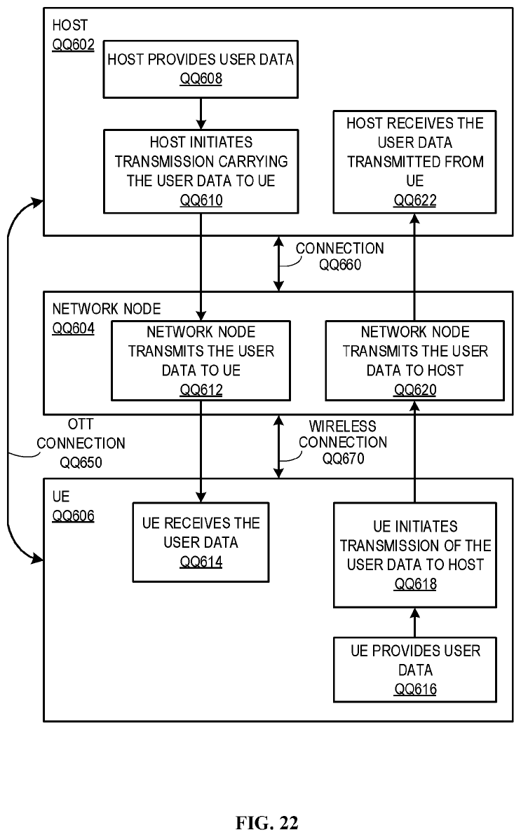

FIG. 22 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 20 and/or UE QQ200 of Figure QQ2), network node (such as network node QQ110a of FIG. 20 and/or network node QQ300 of Figure QQ3), and host (such as host QQ116 of FIG. 20 and/or host QQ400 of FIG. 21) discussed in the preceding paragraphs will now be described with reference to FIG. 22.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 20) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may effectively avoid the accuracy degradation due to the interference, therefore improve the reliability of AC in the scenarios that the interference exists and thereby provide benefits such as improving quality of service and/or Quality of Experience.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Embodiment 1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the operations related to the wireless device as described above to transmit the user data from the host to the UE:

Embodiment 2. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the operations related to the wireless device as described above to transmit the user data from the host to the UE:

Embodiment 4. The method of the previous embodiment, further comprising, at the network node, transmitting the user data provided by the host for the UE.

Embodiment 5. The method of any of the previous 2 embodiments, wherein the user data is provided at the host by executing a host application that interacts with a client application executing on the UE, the client application being associated with the host application.

Embodiment 6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the operations related to the wireless device as described above to transmit the user data from the host to the UE:

Embodiment 7. The communication system of the previous embodiment, further comprising:
the network node; and/or
the user equipment.

Embodiment 8. The communication system of the previous 2 embodiments, wherein:
the processing circuitry of the host is configured to execute a host application, thereby providing the user data; and
the host application is configured to interact with a client application executing on the UE, the client application being associated with the host application.

Embodiment 9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform the operations related to the wireless device as described above to receive the user data from the UE for the host:

Embodiment 10. The host of the previous 2 embodiments, wherein:
the processing circuitry of the host is configured to execute a host application, thereby providing the user data; and
the host application is configured to interact with a client application executing on the UE, the client application being associated with the host application.

Embodiment 11. The host of the any of the previous 2 embodiments, wherein the initiating receipt of the user data comprises requesting the user data.

Embodiment 12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the operations related to the wireless device as described above to receive the user data from the UE for the host:

Embodiment 13. The method of the previous embodiment, further comprising at the network node, transmitting the received user data to the host.

Embodiment 14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the operations related to the wireless device as described above to receive the user data from the host:

Embodiment 15. The host of the previous embodiment, wherein the cellular network further includes a network node configured to communicate with the UE to transmit the user data to the UE from the host.

Embodiment 16. The host of the previous 2 embodiments, wherein:
the processing circuitry of the host is configured to execute a host application, thereby providing the user data; and
the host application is configured to interact with a client application executing on the UE, the client application being associated with the host application.

Embodiment 17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs the operations related to the wireless device as described above to receive the user data from the host:

Embodiment 18. The method of the previous embodiment, further comprising:
at the host, executing a host application associated with a client application executing on the UE to receive the user data from the UE.

Embodiment 19. The method of the previous embodiment, further comprising:
at the host, transmitting input data to the client application executing on the UE, the input data being provided by executing the host application,
wherein the user data is provided by the client application in response to the input data from the host application.

Embodiment 20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the operations related to the wireless device as described above to transmit the user data to the host:

Embodiment 21. The host of the previous embodiment, wherein the cellular network further includes a network node configured to communicate with the UE to transmit the user data from the UE to the host.

Embodiment 22. The host of the previous 2 embodiments, wherein:
the processing circuitry of the host is configured to execute a host application, thereby providing the user data; and
the host application is configured to interact with a client application executing on the UE, the client application being associated with the host application.

Embodiment 23. A method implemented by a host configured to operate in a communication system that further includes a network node and a user equipment (UE), the method comprising:
at the host, receiving user data transmitted to the host via the network node by the UE, wherein the UE performs the operations related to the wireless device as described above to transmit the user data to the host:

Embodiment 24. The method of the previous embodiment, further comprising:
at the host, executing a host application associated with a client application executing on the UE to receive the user data from the UE.

Embodiment 25. The method of the previous embodiments, further comprising:
at the host, transmitting input data to the client application executing on the UE, the input data being provided by executing the host application,
wherein the user data is provided by the client application in response to the input data from the host application.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a wireless device, comprising:
transmitting an antenna calibration signal in at least one antenna of an advanced antenna system;
receiving the AC signal from the AAS via mutual coupling;
identifying at least one interference signal in the received AC signal in a beam space; and
suppressing the at least one interference signal in the received AC signal in the beam space.

2. The method according to claim 1, wherein the at least one interference signal in the received AC signal comprises at least one of:
an external interference signal,
a reflected signal from an outside object, or
a leakage signal.

3. The method according to claim 1, wherein suppressing the at least one interference signal in the received AC signal in the beam space comprises:
suppressing at least one interference beam non-overlapped with at least one AC beam in the received AC signal in the beam space; and/or
suppressing at least one interference beam overlapped with the at least one AC beam in the received AC signal in the beam space.

4. The method according to claim 3, wherein suppressing at least one interference beam non-overlapped with at least one AC beam in the received AC signal in the beam space comprises:
converting the received AC signal from an antenna space to the beam space to obtain a first converted AC signal;
identifying at least one AC beam in the first converted AC signal;
identifying at least one interference beam in the first converted AC signal;
removing the at least one interference beam from the first converted AC signal; and
converting the first converted AC signal removing the at least one interference beam from the beam space to the antenna space.

5. The method according to claim 4, wherein the received AC signal is converted from the antenna space to the beam space by a spatial-domain Fourier transform matrix.

6. The method according to claim 4, wherein identifying at least one AC beam in the first converted AC signal comprises:
obtaining a first mapping between an AC beam index in the beam space and AC signal transmission antenna index; and
identifying the at least one AC beam in the first converted AC signal based on the first mapping.

7. The method according to claim 6, wherein the first mapping is pre-characterized during a production of the AAS or stored in the wireless device.

8. (canceled)

9. The method according to claim 4, wherein identifying at least one interference beam in the first converted AC signal comprises:
constructing a first signal by removing the at least one AC beam from the first converted AC signal; and
when a signal strength of a beam in the first signal is larger than a threshold, identifying the beam as an interference beam.

10. The method according to claim 3, wherein suppressing at least one interference beam overlapped with the at least one AC beam in the received AC signal in the beam space comprises:
adding at least one weight on at least one receiving branch of at least one antenna close to the at least one antenna of the AAS to shift the at least one AC beam to another position in the beam space to enable the at least one interference beam does not overlap with the shifted at least one AC beam;
converting the received AC signal from the antenna space to the beam space to obtain a second converted AC signal;
identifying the shifted at least one AC beam in the second converted AC signal;
identifying the at least one interference beam in the second converted AC signal;
removing the at least one interference beam from the second converted AC signal;
converting the second converted AC signal removing the at least one interference beam from the beam space to the antenna space to obtain a third converted AC signal; and
compensating a phase shift of the third converted AC signal.

11. The method according to claim 10, wherein identifying the shifted at least one AC beam in the second converted AC signal comprises:
obtaining a second mapping between a position in the beam space and the at least one weight; and
identifying the shifted at least one AC beam in the second converted AC signal based on the second mapping.

12. The method according to claim 11, wherein the second mapping is pre-characterized during a production of the AAS.

13. The method according to claim 11, wherein the second mapping is stored in the wireless device.

14. The method according to claim 10, wherein identifying the at least one interference beam in the second converted AC signal comprises:
constructing a second signal by removing the shifted at least one AC beam from the second converted AC signal; and
when a signal strength of a beam in the second signal is larger than a threshold, identifying the beam as an interference beam.

15. The method according to claim 1, further comprising:
performing a calibration on multiple receiving branches of the AAS.

16. The method according to claim 1, further comprising:
determining a signal to interference plus noise ratio of the received AC signal,
wherein when the SINR of the received AC signal is smaller than a threshold, the at least one interference signal in the received AC signal is suppressed.

17. The method according to claim 1, further comprising:
determining a SINR of the received AC signal after at least one interference beam non-overlapped with at least one AC beam in the received AC signal is suppressed,
wherein when the SINR of the received AC signal after interference suppression is smaller than a threshold, at least one interference beam overlapped with the at least one AC beam in the received AC signal is suppressed.

18. The method according to claim 1, further comprising:
calibrating the AAS based on the received AC signal after interference suppression.

19. A wireless device, comprising:
a processor; and
a memory coupled to the processor, said memory containing instructions executable by said processor, whereby the wireless device is operative to:
transmit an antenna calibration signal in at least one antenna of an advanced antenna system;
receive the AC signal from the AAS via mutual coupling;
identify at least one interference signal in the received AC signal in a beam space; and
suppress the at least one interference signal in the received AC signal in the beam space.

20. The wireless device according to claim 19, wherein the at least one interference signal in the received AC signal comprises at least one of:
an external interference signal,
a reflected signal from an outside object, or
a leakage signal.

21. A computer-readable storage medium storing instructions which when executed by at least one processor, cause the at least one processor to perform steps comprising:
transmit an antenna calibration signal in at least one antenna of an advanced antenna system;
receiving the AC signal from the AAS via mutual coupling;
identify at least one interference signal in the received AC signal in a beam space; and
suppress the at least one interference signal in the received AC signal in the beam space.

22. (canceled)
